(19) United States
(12) Patent Application Publication
(10) Pub. No.: US 2011/0209604 A1
(43) Pub. Date: Sep. 1, 2011

(54) COMPOSITE ARMOR PANEL

(75) Inventors: Thomas D. Rockaway, Shelbyville, KY (US); Gerold A. Willing, Louisville, KY (US)

(73) Assignee: UNIVERSITY OF LOUISVILLE RESEARCH FOUNDATION, INC., Louisville, KY (US)

(21) Appl. No.: 12/844,089

(22) Filed: Jul. 27, 2010

Related U.S. Application Data
(60) Provisional application No. 61/228,762, filed on Jul. 27, 2009.

(51) Int. Cl. F41H 5/04; B29C 43/18

(52) U.S. Cl. 89/36.02; 156/245; 89/904; 89/910; 89/917

(57) ABSTRACT

A composite armor panels is comprised of a first layer, composed of a matrix of an elastomeric material and a crushed aggregate material, and a second backing layer. One or more geogrids can be included in the first layer of the armor panel to prevent the aggregate material from moving within the first layer. A method of making a composite armor panel includes exposing a mixture of elastomeric material and crushed aggregate material to elevated temperatures and pressures for predetermined time periods, such that a matrix of elastomeric material and crushed aggregate material is formed.

### RELATED APPLICATIONS

This application claims priority to U.S. Application Ser. No. 61/228,762 filed on Jul. 27, 2009, the entire disclosure of which is incorporated herein by this reference.

### TECHNICAL FIELD

The presently-disclosed subject matter relates to a composite armor panel. In particular, the presently-disclosed subject matter relates to a composite armor panel that is comprised of a first layer, composed of a matrix of an elastomeric material and a crushed aggregate material, and a second backing layer.

### BACKGROUND OF THE INVENTION

For the past several decades, military and civilian researchers have been searching for materials that will provide effective, lightweight protection against armor piercing rounds. Ceramic and KEVLAR® materials have been shown to provide a substantial amount of protection when applied to vehicles or body armor. (KEVLAR® is a registered trademark of E.I. du Pont de Nemours and Company of Wilmington, Del.) However, while these materials are effective, they are expensive and are thus typically reserved for critical applications, and not for structures such as airports, banks, shopping malls, financial institutions, and schools.

Previously, a matrix of bitumen and stone, known as “plastic armour,” was identified as a low-cost material that that could provide the necessary protection for these structures. Plastic armour is a wafer consisting of at least two inches of a bitumen-granite matrix overlaying a thin steel plate, and is capable of preventing many armor-piercing projectiles from piercing its steal plate. Nevertheless, because of its composition, it is not economically feasible or practical to incorporate plastic armour into many civilian structures.

Thus, there remains a need for an armor panel that is both economically feasible to produce and practical to incorporate into civilian structures, but yet is still capable of providing the necessary protection for these structures.

### SUMMARY OF THE INVENTION

The presently-disclosed subject matter relates to a composite armor panel that makes use of an elastomeric material and a crushed aggregate material to provide a composite armor panel that is capable of being inexpensively manufactured and incorporated into common building structures, yet is still able to provide protection for the structure as well as its occupants.

In some embodiments, a composite armor panel is comprised of two layers: a first layer, composed of a matrix of an elastomeric material and a crushed aggregate material; and a second backing layer. The elastomeric material of the first layer can be selected from a variety of materials including rubber or plastic. Similarly, the crushed aggregate material can also be selected from a variety of materials, including, granite, limestone, ceramic, silicon carbide, or combinations thereof. In one embodiment, the elastomeric material is rubber, and the crushed aggregate material is granite.

Depending upon the intended application, the ratio of elastomeric material to aggregate material can be varied, and/or the thickness of the matrix can be increased to provide a first layer with tunable properties and with desired performance characteristics. In some embodiments, the first layer of the panel is comprised of an amount of the elastomeric material that is equal to or greater than about 60% by weight of the first layer. For example, in certain embodiments, the first layer includes about 75% by weight of the elastomeric material and about 25% by weight of the crushed aggregate material. As another example, in other embodiments, the first layer includes about 90% by weight of the elastomeric material and about 10% by weight of the crushed aggregate material. As yet another example, in some embodiments, to produce an armor panel with tunable properties and with desired performance characteristics, the thickness of the first layer of the armor panel is varied from about 0.5 inches to about 1.5 inches. Of course, varying the thickness of the armor panel can be done with and without varying the amount of elastomeric material and crushed aggregate material in the armor panel.

In some embodiments, to provide additional strength to an exemplary armor panel, a composite armor panel is provided that incorporates one or more geogrids into the matrix of the first layer. When more than one geogrid is incorporated into a matrix of an exemplary armory panel, each geogrid is typically spaced at a predetermined distance from each adjacent geogrid, such that the crushed aggregate material of the matrix is held in place throughout the matrix.

As noted, an exemplary composite armor panel further includes a second backing layer. In some embodiments, the second backing layer is in the form of a steel plate that provides a further barrier to prevent projectiles or the like from penetrating through an exemplary armor panel. In other embodiments, the second backing layer is a geomembrane that reduces the overall weight of the armor panel, but yet still provides a second backing layer with both high tear resistance and high deformation resistance.

Further provided are methods for making a composite armor panel. In some embodiments, an exemplary armor panel is made by creating a mixture of an amount of an elastomeric material and an amount of a crushed aggregate material. The mixture is then placed in a mold. The mold is then exposed to an elevated temperature and an elevated pressure for a predetermined time period, such that a matrix, composed of the elastomeric material and the crushed aggregate material, is formed. The mold and the matrix are then allowed to cool prior to removing matrix from the mold. In some embodiments, a backing layer is then attached to the resultant matrix to produce an armor panel that includes an additional protective barrier.

In certain embodiments, to produce an exemplary armor panel, the elastomeric material and the crushed aggregate material are exposed to an elevated temperature of about 130° C. to about 160° C. and an elevated pressure of about 6000 lbs/in² for about 90 to about 180 minutes to thereby produce the armor panel. In some embodiments, the elastomeric material and the crushed aggregate material are exposed in a stepwise manner to elevated temperatures and elevated pressures for varying time periods, such that the elastomeric materials and the crushed aggregate materials are exposed to a series of elevated temperatures and elevated pressures for successive time periods to thereby produce a desired composite armor panel.

### DESCRIPTION OF THE DRAWINGS

FIG. 1 is a perspective view of an exemplary composite armor panel made in accordance with the presently-disclosed subject matter, and showing a first layer of the armor panel, composed of a matrix of an elastomeric material and a crushed aggregate material, and a second backing layer;

FIG. 2 is a cross-sectional view of the exemplary composite armor panel of FIG. 1, taken along line 2-2 of FIG. 1, and showing the crushed aggregate material dispersed throughout the first layer.

FIG. 3 is a perspective view of an exemplary geogrid used in accordance with presently-disclosed subject matter.

FIG. 4 is a perspective view of another exemplary composite armor panel made in accordance with the presently-disclosed subject matter, but with selected portions of the armor panel removed to show a geogrid incorporated into the matrix of the first layer.

FIG. 5 is a perspective view of yet another exemplary composite armor panel made in accordance with the presently-disclosed subject matter, but showing two geogrids incorporated into the matrix of the first layer and spaced at a predetermined distance from one another.

FIG. 6 is a perspective view of still another exemplary composite armor panel made in accordance with the presently-disclosed subject matter, but showing three geogrids incorporated into the matrix of the first layer and spaced at a predetermined distance from each adjacent geogrid.

FIG. 7 is a graph showing the amount of deflection (in.), as a function of load (lbs.), that was observed in exemplary armor panels that included a 1-inch thick matrix and three geogrids, and were either composed of 10% granite and 90% rubber by weight or were composed of 25% granite and 75% rubber by weight.

### DESCRIPTION OF EXEMPLARY EMBODIMENTS

The presently-disclosed subject matter includes a composite armor panel that is capable of being inexpensively manufactured and incorporated into common building structures to provide protection for the structure as well as its occupants.

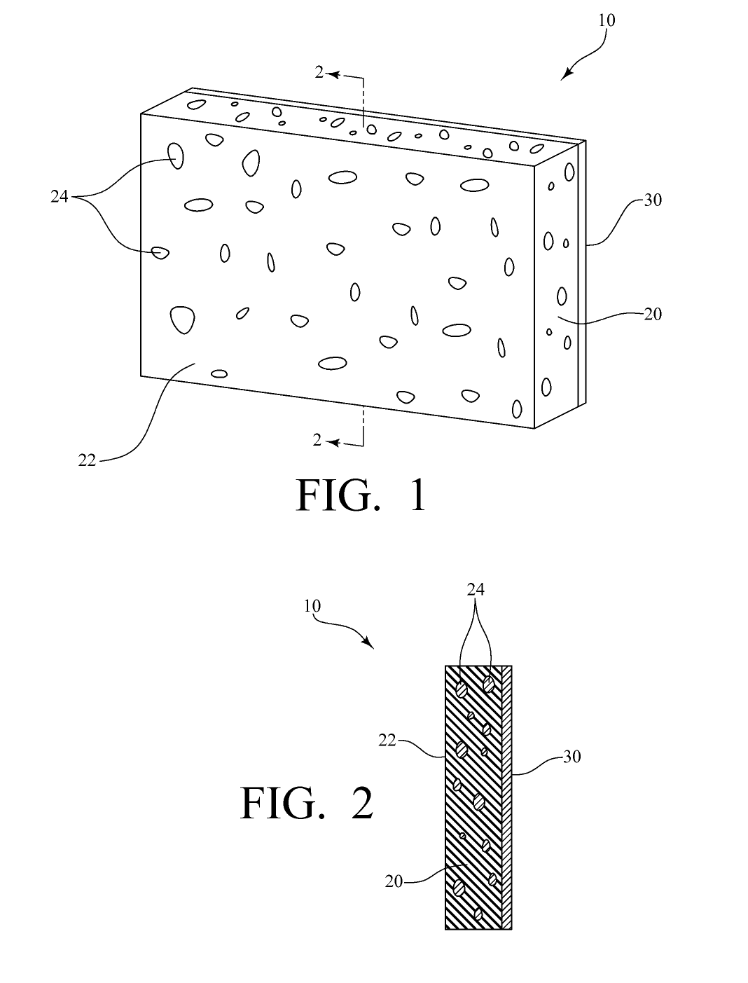

Referring first to FIGS. 1 and 2, an exemplary composite armor panel 10 made in accordance with the presently-disclosed subject matter is comprised of two layers: a first layer 20, which is composed of an elastomeric material 22 and a crushed aggregate material 24, and a second backing layer 30. As shown in FIGS. 1 and 2, the elastomeric material 22 and the crushed aggregate material 24 are combined together in the first layer 20, such that a matrix of elastomeric material 22 and crushed aggregate material 24 is formed. By incorporating the elastomeric material 22 and the crushed aggregate material 24 into a matrix, the first layer 20 of the composite armor panel 10 is not only non-volatile and heat-resistant, but is also stable and capable of maintaining its shape after it is impacted by a projectile, such as a bullet.

Various elastomeric materials can be used to construct the composite armor panel 10. In some embodiments, the elastomeric material 22 comprises a rubber or a plastic. For example, suitable elastomeric materials include natural rubber, neoprene, styrene-butadiene rubber (SBR), nitrile, ethylene propylene diene M-class rubber (EPDM), or other elastomers or plastics (such as those with a cross-linked structure) that will maintain their morphology over long periods of time and through applications of heat and stress.

With respect to the crushed aggregate materials, a variety of crushed aggregate materials can be combined with the elastomeric materials to produce a suitable matrix. In some embodiments, the crushed aggregate material 24 is selected from granite, limestone, ceramic, silicon carbide, other alumino-silicate materials, or combinations thereof. Of course, other crushed aggregate materials can also be used without departing from the spirit and scope of the presently-disclosed subject matter.

In many cases, the selection of an appropriate aggregate material is dependent, at least in part, on its hardness characteristics with respect to the elastic modulus of the surrounding elastomeric material in the matrix. Additionally, a particular aggregate material can also be chosen for a particular application based on the strength, hardness, and durability of the particular aggregate material, such that the selection of the aggregate material relates to the impact energy that must be resisted in a specific application. In other words, a particular aggregate material can, in some instances, be chosen based on the mass of the projectile that will impact the aggregate material, the velocity at which the projectile will impact the aggregate material, and the distance the projectile must travel before it impacts the aggregate material and the panel. For example, it has been experimentally observed that particles of crushed granite material having an average diameter of approximately ⅜ inch are sufficient to prevent a bullet from penetrating the backing layer 30 of an exemplary panel when a 9-mm handgun was fired at the panel from a range of 10 yards and impacted the panel with an energy of 350 foot-pounds. Of course, the selection and size of other aggregate materials for a particular application can readily be determined through routine experimentation. In some embodiments, the size of a particular aggregate material is on the same scale as the size of the projectile that must be resisted by an exemplary armor panel. For instance, to adequately resist the impact of a 9-mm bullet, aggregate material particles having an average diameter of approximately ⅜ inch can be incorporated into an exemplary armor panel.

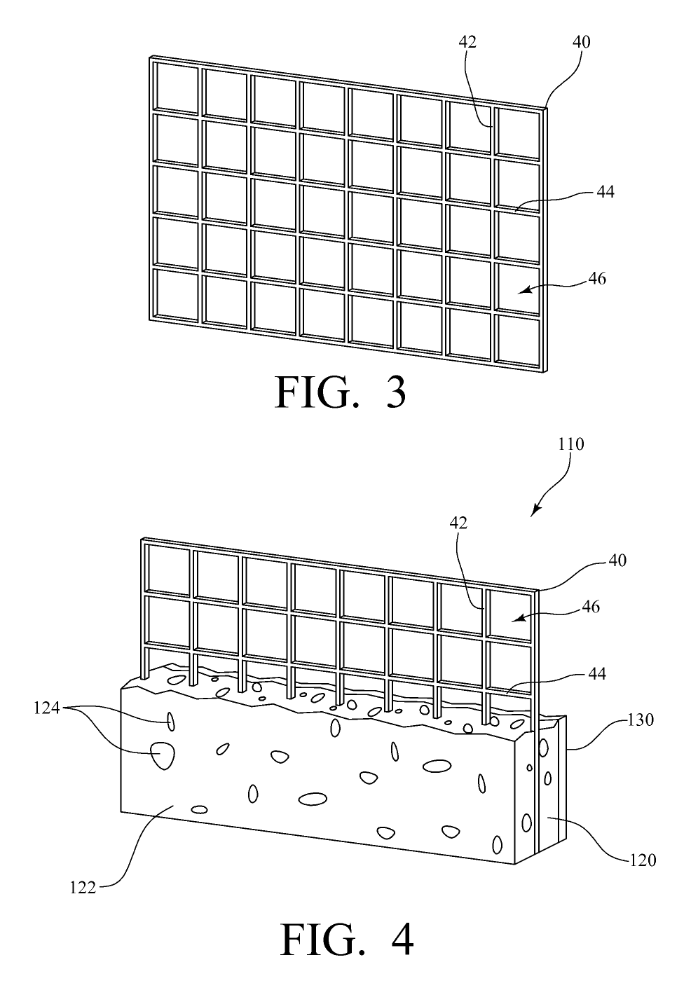

Referring now to FIGS. 3-4, the first layer 120 of an exemplary composite armor panel 110 can, in some embodiments, further include a geogrid 40 or other polymeric mesh material (such as nylon, polyethylene, polypropylene, or polyester-based fiber) that is incorporated into the matrix of elastomeric material 122 and crushed aggregate material 124. As shown in FIG. 3, the geogrid 40 is comprised of series of longitudinal ribs 42 and transverse ribs 44 that are joined together to define openings 46 in the geogrid 40. Typically, geogrids 40 are comprised of a stretched polypropylene material and are often used to provide additional support for stone pavement subgrades, as they prevent gravel particles from moving down and laterally within the subgrades. By incorporating the geogrid 40 into the matrix of the composite armor panel 110, as shown in FIG. 4, the geogrid 40 confines the individual particles of crushed aggregate material 124 within the first layer 120 and prevents the movement of the crushed aggregate material 124, such that it is able to provide additional strength to the first layer 120 of the composite armor panel 110, and thus allow the first layer 120 to resist an increased amount of vertical force and disperse loads over a greater area. For example, it has been experimentally observed that when a bullet is fired into the composite armor panel 110 that incorporates the geogrid 40, the resulting indentation in the second backing layer 130, which is commonly formed from a steel plate, is shallower and has a greater surface area than what is observed when a bullet is fired into a panel that does not include a geogrid, such as the composite armor panel 10 shown in FIG. 1.

Referring still to FIG. 4, and with further regard to the geogrid 40, the placement of the geogrid 40, the strength of the geogrid 40, and the size of the openings 46 in the geogrid 40 can be chosen based upon the desired interaction of the surrounding matrix of elastomeric material 122 and crushed aggregate material 124 with the geogrid 40. In this regard, each of these characteristics are generally selected based on the impact energy that must be resisted by the panel 110 in a particular application as well as the size of the aggregate material 124 that is being used in the panel 110. For applications requiring a greater amount of impact energy to be resisted, the strength of the geogrid 40 can readily be tuned by increasing the size (e.g., the diameter) of the longitudinal ribs 42 and the transverse ribs 44 of the geogrid 40. Typically, the size of the openings 46 in the geogrid 40 are determined by the size of the aggregate materials that are included in the panel 110, with the size of the openings 46 being slightly larger than the size of the aggregate material used in the panel 110. For example, in some embodiments, granite particles with an average diameter of approximately ⅜ inch are used as the aggregate material in combination with a geogrid with openings of approximately 1 inch by 1½ inches, as such a ratio of aggregate size to geogrid opening size has been found to sufficiently absorb the impact energy of a number of projectiles, including, for example, 9-mm bullets. Of course, the selection of a geogrid having openings of a particular size for a particular application and/or size of an aggregate material can also readily be determined through routine experimentation.

Furthermore, and without wishing to be bound by any particular theory, it is believed that the geogrid 40 optimally improves the strength and deformation resistance properties of the first layer 120 if the geogrid 40 is placed in the center or latter half of the first layer 120 (i.e., closest to the second backing layer 130). For example, as shown in FIG. 4, the geogrid 40 can be placed in the center of the first layer 120, such that the distance from the geogrid 40 to the front of the first layer 120 is the same as the distance from the geogrid 40 to the second backing layer 130.

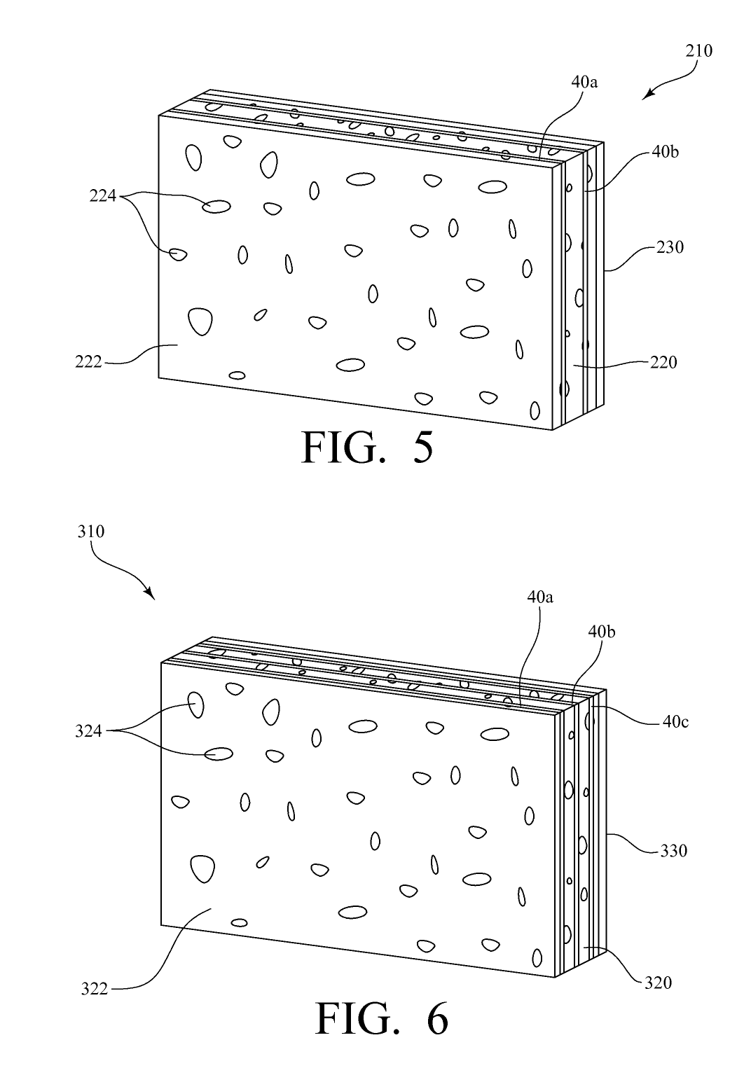

Referring now to FIGS. 5 and 6, in some embodiments of the presently-disclosed subject matter, composite armor panels 210, 310 are provided that incorporate multiple geogrids 40a, 40b, 40c into the first layer 220, 320, of the composite armor panels 210, 310. Similar to the composite armor panel 110 shown in FIG. 3, the composite armor panels 210, 310 are comprised of a first layer 220, 320, composed of a matrix of elastomeric material 222, 322 and crushed aggregate material 224, 324, and a second backing layer 230, 330. However, unlike the composite armor panel 110 shown in FIG. 3, the composite armor panels 210, 310 incorporate two or three geogrids 40a, 40b, 40c, respectively, into the first layer 220, 320, of the composite armor panels 210, 310. The geogrids 40a, 40b, 40c are typically spaced at a predetermined distance (e.g., equidistantly) from each adjacent geogrid 40a, 40b, 40c, such that the individual particles of crushed aggregate material 224, 324 are further prevented from moving within the first layer 220, 320 and additional strength is imparted to the first layer 220, 320 of the composite armor panel 210, 310, as compared to embodiments incorporating only one geogrid 40 (as in FIG. 4). As would be recognized by those skilled in the art, the incorporation of multiple geogrids 40a, 40b, 40c within the first layer 220, 320 of the composite armor panel 210, 310 is particularly useful in embodiments where the thickness of the composite armor panel 210, 310 is increased and an increased amount of aggregate material 224, 324 is utilized in the first layer 220, 320. Of course, to the extent it may be desired, any number of geogrids can be incorporated into an exemplary armor panel, including armor panels with first layers of varying thickness, without departing from the spirit and scope of the subject matter disclosed herein.

Referring again to FIGS. 1 and 2, and as described above, the exemplary composite armor panel 10 also includes a second backing layer 30 that is attached to the first layer 20. As shown in FIGS. 1 and 2, in some embodiments, this second backing layer 30 is in the form of a steel plate (e.g., a 14-gauge steel plate) that provides a further barrier to prevent projectiles from penetrating through the composite armor panel 10. To the extent is may be desired, and as would be recognized by those skilled in the art, the second backing layer 30 can also be made of other metals, such as aluminum, and can be provided in various thicknesses or densities. Further, in some embodiments, the second backing layer 30 is not comprised of a metal, but is instead comprised of a material such as a geomembrane (not shown). By incorporating a geomembrane (e.g., a 40 mm-thick geomembrane comprised of an HDPE material) into an exemplary armor panel, the overall weight of the armor panel can be significantly reduced without significantly reducing the level of protection afforded by the armor panel, as the geomembrane still provides both high tear resistance and a high resistance to deformation.

Further provided, in some embodiments of the presently-disclosed subject matter, are methods for making a composite armor panel. In one exemplary implementation, an elastomeric material is first provided and is cut to a size and gradation that is similar to, or smaller, than the individual particles of the crushed aggregate material that is selected to be combined with the elastomeric material and used produce a first layer of the armor panel. Once the elastomeric material is cut, a mixture is created with an amount of the elastomeric material and an amount of crushed aggregate. The mixture is then placed into a mold of a desired size and shape alone or with a geogrid that has been cut to the shape of the mold. Depending upon the particular elastomeric material used to produce the armor panel, the mold can first be pre-treated with an agent (e.g., talc) that allows the elastomeric material and crushed aggregate material to later be easily released from the mold. However, regardless of whether a releasing agent is used, once the elastomeric material and aggregate material, with or without one or more geogrids, are placed in the mold, the mold is then placed between steel plates and is loaded onto a machine that exposes the mold to elevated temperatures while simultaneously engaging the steel plates and compressing the mold, such that the mold is also exposed to an elevated pressure. This simultaneous exposure of the mold to an elevated temperature and pressure serves to melt the elastomeric material and produce a matrix of elastomeric material and crushed aggregate material of sufficient density that is able to withstand an impact by a projectile, such as a bullet, without losing its shape or integrity.

After a predetermined amount of time has passed and the matrix of elastomeric material and crushed aggregate material has been formed, the mold is then removed from the machine and allowed to cool. Once the mold has cooled, the resulting matrix of elastomeric material and crushed aggregate material can then be removed from the mold and affixed to a second backing layer, such as by using a suitable adhesive or other means for securing two layers together.

In some embodiments, the step of exposing the elastomeric material and crushed aggregate material in the mold to an elevated temperature and an elevated pressure comprises exposing the mold to a series of elevated temperatures and elevated pressures. In some embodiments, the series of elevated temperatures and pressures can be selected based on the desired thickness of the first layer of the armor panel that is being produced. For example, in one exemplary implementation, a first layer of an exemplary armor panel with a thickness of 0.5 or 1-inch is made by exposing the elastomeric and crushed aggregate material to a temperature of 130° C. for 15 minutes under a load of 6000 lbs/in², followed by exposing the elastomeric and crushed aggregate material to a temperature of 150° C. for 15 minutes and 160° C. for 60 minutes under the 6000 lbs/in² load. In another exemplary implementation, a first layer of an armor panel with a thickness of 1.5-inches is made by exposing the elastomeric and crushed aggregate material to a temperature of 130° C. for 30 minutes under a load of 6000 lbs/in², followed by exposing the elastomeric material and crushed aggregate material to a temperature of 150° C. for 30 minutes and 160° C. for 120 minutes under the 6000 lbs/in² load. Of course, armor panels of other thicknesses can also be made in accordance with the presently-disclosed subject matter and the elevated temperatures and pressures, as well as the time periods required to produce these other armor panels, that are required to produce these panels of varying thickness can be readily determined using only routine experimentation.

Indeed, it is contemplated that the shape, thickness, density, elastomer material properties, aggregate material properties, and other factors and characteristics of an exemplary armor panel can readily be tailored to meet desired performance characteristics and intended applications. For example, depending upon the desired performance characteristics and the intended application, the ratio of elastomeric material to aggregate material can be varied, the composite thickness can be modified, and/or the backing layer thickness can be increased to meet a desired performance characteristic or intended application.

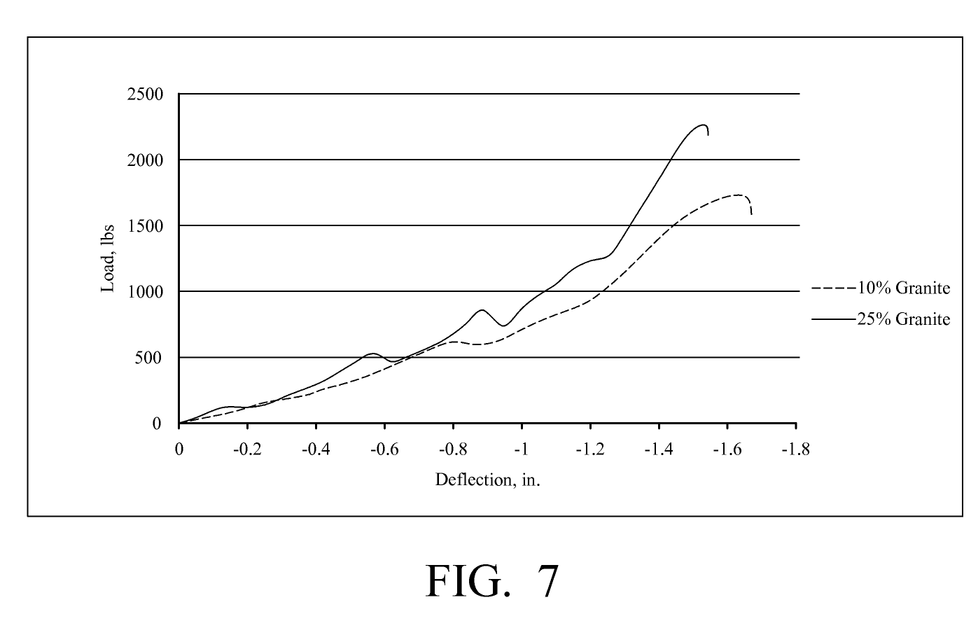

With respect to the ratio of elastomeric material to the crushed aggregate material, in some embodiments, this ratio can be varied to produce armor panels of tunable properties. By increasing the amount of crushed aggregate material in the first layer of the panel relative to the amount of elastomeric material, a composite armor panel can be produced that is more resistant to penetration by a projectile, such as a bullet. It has been experimentally observed that by increasing the crushed aggregate content of the first layer of the panel, once a bullet penetrates the first layer, the bullet shatters a larger amount of stone, and thus dissipates more energy as it passes through the first layer of the panel. In some embodiments of the presently-disclosed composite armor panels, the first layer of the panel is comprised of an amount of elastomeric material that is equal to or greater than about 60% by weight of the first layer. In some embodiments, the first layer includes about 75% by weight of the elastomeric material (e.g., rubber) and about 25% by weight of the crushed aggregate material (e.g., granite). In other embodiments, the first layer includes about 90% by weight of the elastomeric material and about 10% by weight of the crushed aggregate material. Of course, other amounts and ratios of elastomeric material to aggregate material can be used. However, preferred ratios will typically include less aggregate material than elastomeric material for weight savings, and because it has been experimentally observed that, although greater penetration resistance is obtained with larger proportions of aggregate material (see FIG. 7), matrices that are comprised of an equal amount of elastomeric material and aggregate material are prone to cracking and are frequently unable to maintain their integrity.

As a further refinement, and as discussed above, the thickness of the first layer of the panel can also be varied to provide a panel with tunable properties. By increasing the thickness of the first layer, an armor panel can be provided that also increases the penetration resistance of the panel to projectiles. Of course, increasing the thickness of the first layer of the panel will also increase the weight of the panel. As such, to the extent varying the thickness of the first layer is desired, a particular thickness of the first panel can be selected such that the thickness of the particular panel will be suitable for an intended application or will produce a desired level of penetration resistance. Additionally, the preferred thickness of the first layer can be selected with respect to the ratio of elastomeric material to aggregate material, along with the intended application for the panel. In some embodiments, the thickness of the first panel is about 0.5 to 1.5 inches as it has been determined that panels of such thickness are capable of providing a desired level of penetration resistance without an excessive increase in the weight of the panel.

The above-described composite armor panels, which include a matrix composed of an elastomeric material and a crushed aggregate material, can easily be adapted for use in common building structures. Furthermore, because of the materials that are used to produce the composite armor panels, the panels provide an economic means to safely protect many common civilian structures that could not otherwise be protected. Thus, the composite armor panels of the presently-disclosed subject matter provide convenient alternatives to current armor systems, with the added benefit that the panels can be adapted for a variety of applications, thus making them suitable as a means to protect many different structures.

The presently-disclosed subject matter is further illustrated by the following specific but non-limiting examples.

### EXAMPLES

To examine the ability of an elastomer-stone matrix, backed by a steel plate, to prevent bullet penetration, a number of experiments were undertaken. As an initial point of reference, a thin steel plate (14 gauge thickness) was first shot with a 9 mm handgun at range of 10 yards. Based on preliminary calculations, it was estimated that the energy at impact was about 350 foot-pounds and, thus, the bullet easily penetrated the steel plate.

To then assess the effectiveness of a composite armor panel with a first layer composed of a matrix of an elastomeric material and a crushed aggregate material, and a second backing layer in the form of a thin steel plate (14 gauge thickness), several prototypes, including varying amounts of stone aggregates, were then tested in a firing range with a single shot from a 9-mm handgun at a range of 10 yards. Referring again to FIGS. 1 and 2, in which the elastomeric material and the crushed aggregate material were combined in a ratio of 67:33 (elastomeric material to aggregate material) and the first layer of the elastomer-stone matrix had a thickness of approximately 0.85 inches, the bullet did not penetrate the steel plate. Prototypes with a lower stone content showed significantly more deformation within the steel plate.

To examine the effect of incorporating geogrids within the elastomer-stone matrices, several additional prototypes that incorporated geogrids were also developed and tested as described above. By including the geogrid in the test samples, the “dimple” in the steel plate was noticeably shallower, but had a much greater diameter. Further, with the inclusion of the geogrid, it was evident that significantly less strength and deformation was required from the steel plate.

An armor panel was also developed that contained a geogrid layer, but where the steel plate was replaced with a geomembrane. The 40-mm thick geomembrane was a high-density polyethylene (HDPE) material that provided both tear resistance and high deformation upon testing. While the 9-mm projectile at 10 yards penetrated the matrix, stone crushing was observed, and the impact energy was distributed over a larger area due to the geogrid. Thus, the combination of geogrid and geomembrane backing appeared as a viable alternative that would significantly reduce composite weight.

To further examine the effect of varying the composition of the first layer of an armor panel and the effect of varying the number of geogrids included in the first layer, armor panels, with steel backing layers, were created that were composed of either 90% rubber and 10% granite or 75% rubber and 25% granite. These armor panels included between zero to three geogrids, and varied in thickness from 0.5 inches to 1.0 inches. Armor panels with first layers comprised of 50% rubber and 50% granite were unable to maintain their integrity. Testing of the armor panels was conducted on a 200-kip universal testing machine that fired a metal rod into the armor panels and provided a reproducible impact. In testing each of the armor panels, an initial test was performed in the center of each panel and four additional were performed immediately above, below, and to either side of the initial test.

The testing of the armor panels with a 0.5 inch thickness revealed that the armor panels that included 25% granite were able to withstand a larger load with less deformation of the panel as compared to a panel including 10% granite. Further, it was observed that the armor panels were able to withstand a larger load at the site of the initial test than those of the exterior tests without a change in the amount of deformation observed in the panel. Without wishing to be bound by any particular theory, it is believed that the surrounding area of armor panel provided strength to the central area of the armor panel.

The testing of the armor panels with a 1-inch thickness revealed overall that the load that could be withstood by the panels was greater for the initial tests than for surrounding tests and also again revealed that the armor panels that included 25% granite were able to withstand a larger load with less than or the same amount of deformation of the panel as compared to a panel including 10% granite. For example, as shown in FIG. 7, it was observed that armor panels with a 1-inch thick first layer that included 3 geogrids were able to withstand significantly higher loads, without an accompanying increase in deformation (i.e., deflection), if the armor panels included 25% granite as compared to 10% granite. Furthermore, in comparing panels that included no geogrids or included one or more including geogrids in the first layer of the panel, it was observed that panels without geogrids had considerably more cracks in the panel subsequent to testing, with the cracks expanding out from the point of impact. In panels including one or more geogrids, however, the only visible damage to the panels was directly at the point of impact. This lack of cracks in the geogrid-containing panels indicated that the geogrid was holding the panel together and, more particularly, was holding the granite in place within the first layer of the panel, as compared to panels without geogrids where the granite was able to freely move downward with the rod and therefore create cracks.

One of ordinary skill in the art will recognize that additional embodiments are also possible without departing from the teachings of the presently-disclosed subject matter. This detailed description, and particularly the specific details of the exemplary embodiments and implementations disclosed herein, is given primarily for clarity of understanding, and no unnecessary limitations are to understood therefrom, for modifications will become apparent to those skilled in the art upon reading this disclosure and may be made without departing from the spirit or scope of the presently-disclosed subject matter.

What is claimed is:

1. A composite armor panel comprising:
a first layer composed of a matrix of an elastomeric material and a crushed aggregate material; and
a second backing layer.

2. The composite armor panel of claim 1, wherein the elastomeric material comprises a rubber or a plastic.

3. The composite armor panel of claim 1, wherein the crushed aggregate material comprises granite, limestone, ceramic, silicon carbide, or combinations thereof.

4. The composite armor panel of claim 1, wherein the first layer is comprised of an amount of the elastomeric material equal to or greater than about 60% by weight of the first layer.

5. The composite armor panel of claim 4, wherein the first layer includes about 75% by weight of the elastomeric material and about 25% by weight of the crushed aggregate material.

6. The composite armor panel of claim 4, wherein the first layer includes about 90% by weight of the elastomeric material and about 10% by weight of the crushed aggregate material.

7. The composite armor panel of claim 4, wherein the elastomeric material is rubber and the crushed aggregate material is granite.

8. The composite armor panel of claim 1, wherein the second backing layer is a steel plate.

9. The composite armor panel of claim 1, wherein the second backing layer is a steel plate is a geomembrane.

10. The composite armor panel of claim 1, wherein the first layer further comprises one or more geogrids incorporated into the matrix.

11. The composite armor panel of claim 10, wherein each geogrid is spaced at a predetermined distance from each adjacent geogrid.

12. The composite armor panel of claim 1, wherein the first layer has a thickness of about 0.5 inches to about 1.5 inches.

13. A composite armor panel, comprising:
a first layer composed of a matrix of rubber and crushed granite with one or more geogrids incorporated into the matrix; and
a second backing layer.

14. A method of making a composite armor panel, comprising the steps of:
creating a mixture of an amount of an elastomeric material and an amount of a crushed aggregate material;
placing the mixture in a mold;
exposing the mold to an elevated temperature and an elevated pressure for a predetermined time period, such that a matrix composed of the elastomeric material and the crushed aggregate material is formed;
allowing the matrix to cool; and
removing the matrix from the mold.

15. The method of claim 14, and further comprising the step of adding a backing layer to the matrix.

16. The method of claim 14, wherein the elastomeric material comprises a rubber or a plastic.

17. The method of claim 14, wherein the crushed aggregate material comprises granite, limestone, ceramic, silicon carbide, or combinations thereof.

18. The method of claim 14, wherein the mixture is comprised of an amount of the elastomeric material equal to or greater than about 60% by weight of the matrix.

19. The method of claim 14, wherein the elevated temperature is about 130° C. to about 160° C., the elevated pressure is about 6000 lbs/in², and the predetermined time period is about 90 to about 180 minutes.

20. The method of claim 14, wherein exposing the mold to the elevated temperature and the elevated pressure for the predetermined time period comprises exposing the mold to a series of elevated temperatures and elevated pressures for successive time periods.
